(19) United States
(12) Patent Application Publication
(10) Pub. No.: US 2003/0018118 A1
(43) Pub. Date: Jan. 23, 2003

(54) Microbead coating composition and methods

(76) Inventor: David Burnett, Royal Oak, MI (US)

Correspondence Address: PERMAN & GREEN, 425 POST ROAD, FAIRFIELD, CT, 06824, US

(21) Appl. No.: 09/886,646

(22) Filed: Jun. 21, 2001

(51) Int. Cl. B05D 3/02; B05D 1/02; C08K 3/40

(52) U.S. Cl. 524/494; 427/421; 427/385.5; 523/171

(57) ABSTRACT

Novel microbead coating compositions having improved binding properties for the glass microbeads suspended therein, which compositions also have superior bonding properties for substrates so as to be resistant to peeling or flaking therefrom after drying. These novel binding and bonding properties are unexpectedly produced by the addition of microparticles of ground rubber, crumb rubber or pelletized rubber, to microbead coating compositions containing a resinous binder material and, optionally, other color-enhancing particles such as pigments, glass flakes, metallic flakes, mica and similar materials.

### BACKGROUND OF THE INVENTION

The present invention relates to improved coating compositions containing microparticles, preferably glass beads having an average diameter up to about 70 microns, which are preferably coated to improve their dry flowability and to reduce their wet-out capability. These properties within resinous binder materials affect microparticle bonding properties within plastic coatings, paints, and similar compositions. This invention also relates to methods for producing coating compositions for producing resinous bodies which contain coated particles that are more tightly bonded within the composition, resulting in compositions having improved bonding properties for substrates.

1. Field of the Invention

The present invention is concerned with improving the adhesion or bonding properties of microparticles such as glass beads, plastic beads, glass flakes, mica and similar pigment and color-enhancing materials within coating compositions, and improving the adhesive or bonding properties of such compositions for substrates such as metal automobile bodies, appliances, etc. Particles of such materials normally have a surface affinity and attraction for each other, particularly in the presence of moisture, so that they have poor flowability properties in bulk, such as from within a container. This results in the particles forming clusters, agglomerates or build-ups of a plurality of flakes, beads or other particles, which interfere with their handling properties, metering properties and the aesthetic nature of the particles for their desired characteristics, such as color uniformity, light reflection or refraction and similar properties, as well as avoidance of significant reduction in impact strength caused by the addition of agglomerates to plastics.

2. State of the Art

It is known to improve the dispersing, orienting or migration properties of the aforementioned microparticles within liquid plastic compositions, such as solvent coating compositions, whereby the microparticles are not merely wetted and drawn by gravity down into the depth of the coating.

It is known to add thickeners such as asbestine pigment to resinous paint solutions containing microbeads to prevent or retard settling during the spray-application of reflective highway paints, and to coat the beads with thin organophilic films to improve adhesion or affinity or wettability of the beads in the resinous binder material, and reference is made to U.S. Pat. No. 2,574,971.

It is also known to coat microbeads with adhesion promoters, including organosilanes, such as 3-aminopropyltriethoxysilane or 3-methacryloxypropyltrimethoxysilane to insure that the microbeads are firmly secured to the substrate in a retroreflective screen printing ink having a resinous binder material. Reference is made to U.S. Pat. No. 5,650,213.

Also, U.S. Pat. No. 5,736,602 discloses the addition of colloidal suspending agents to curable thermosetting resinous coating compositions containing glass microspheres to retain the glass beads in suspension in the resin binder system.

It is also known to coat glass microparticles to render them repellent to each other, to avoid clustering and agglomeration and to improve flowability, and/or to make them repellent to resinous or plastic binder materials to improve their distribution and/or predetermine their location within resinous or plastic coatings, extrusions or molded products, and reference is made to co-pending application U.S. Ser. No. 09/752,305 filed on Dec. 12, 2000.

Said co-pending application relates to the coating of microparticles such as glass beads, plastic beads, glass flakes, mica, pigments and similar color-enhancing particulate materials, particularly glass microspheres having average particles sizes up to about 75μ, preferably from about 1μ up to about 20μ, with materials which bond to the particles' surfaces and impart flowability to the particles in bulk and from their packages containing uniform dispersions of the particles in compositions, particularly compositions containing plastic or resinous binder materials for applying liquid coatings, or for extruding plastic rods, fibers or films, or for molding plastic bodies.

According to a preferred embodiment of said co-pending application, free-flowing self-repelling microparticles are produced which can be easily compounded into conventional resinous or plastic compositions, without the need for thickening or viscosity-increasing additives, but said particles are also repelled to predetermined and/or different degrees by compositions into which they are compounded, most particularly by the plastic or resinous binder materials thereof, to produce compositions in which the glass microbeads are not as strongly bonded as desired, and compositions which have reduced adhesiveness or bonding properties for substrates.

These adhesion problems apply generally to all coating compositions or paints containing glass microbeads and resinous binder materials. Glass microbeads have smooth, inert surfaces which repel the resinous binder material which is intended to bind the microbeads within the coating composition and to bond the dried coating, such as paint, to the substrate.

### SUMMARY OF THE INVENTION

The present invention relates to providing novel microbead coating compositions having improved binding properties for the glass microbeads suspended therein, which compositions also have superior bonding properties for substrates so as to be resistant to peeling or flaking therefrom after drying. According to the present invention these novel binding and bonding properties are unexpectedly produced by the addition of microparticles of ground rubber to microbead coating compositions containing a resinous binder material and, optionally, other color-enhancing particles such as pigments, glass flakes, metallic flakes, mica and similar materials as disclosed in co-pending U.S. Ser. No. 09/752,305, discussed supra. The rubber particles, known as crumb rubber and pelletized rubber are commercially-available from Spreerelast GmbH, Ardennering, Germany under the trademark Relaston® MT and DT (devulkanized) having grain or particle sizes of 100μ, 120μ, 150μ, 160μ, 180μ, and larger. The rubber particles are produced cryogenically by freezing and grinding scrap tire rubber elastomer to the desired grain size and smooth surface. Particles having a grain size of 150μ or less are preferred for use in the present compositions. They have the appearance of a powder and are gray in color.

The rubber particles are effective in amounts between about 2% up to about 40% by weight of the total solids content of the coating composition, more preferably between about 5% and 20%. The darkish color and opacity of the rubber particles reduces or tones down the normal light-refracting, light-diffusing properties which the microbead composition has in the absence of the rubber particles, but the formed coatings or paints are aesthetically-attractive since they exhibit a depth of color, particularly when pigmented black or gray or silver and used as automobile paints.

More importantly, the present coating compositions exhibit excellent affinity for substrates to which they are applied, such as by spray painting, and bond strongly thereto when dried and/or heat-cured /or baked. Similarly, the microparticles are strongly bonded within the formed coatings by the resinous binder material and are resistant to separation therefrom, which can result in cracking, and flaking of the coating. It is unclear how or why the rubber microparticles modify the present compositions to improve the affinity of the glass microbeads for the resinous binder material and to increase the affinity of the coating composition or paint for substrates, but it appears that the rubber particles have a greater affinity for the resinous binder material and for the glass microbeads than these materials have for each other, thereby linking these materials to each other and to the coated substrates.

The present coating or paint compositions are formulated as high solids content, heat-curable, compositions containing embedded or encapsulated light-refractive colorless and/or tinted transparent glass beads, preferably between about 10 to 20 microns diameter, rubber microparticles, and one or more color-enhancing agents such as pigments, dyes, aluminum flakes, colored aluminum flakes, mica, metallized mica, holographic flakes, phosphorescent glass beads and similar light-enhancing agents. Alternatively, some of the color enhancing agents may be present in a colored base coating over which the glass bead-embedded coating composition is applied, to cause light reflected by the base coat to be refracted and dissipated across the transparent glass bead layer, whereby the intensity and richness of the color or appearance of the combined layers is substantially enhanced.

While the present paint compositions may contain some beads which are opaque and/or retroreflective, such as hemispherically- or fully-metallized glass beads, or phosphorescent-coated beads, it is essential that a substantial content of the beads comprises light-refractive, clear or tinted glass beads which function as light diffusers within the semi-opaque translucent paint layer to scatter direct and indirect light, including colored light, in all directions across the paint layer.

The scattered light may have the color of a reflective base layer, or may become colored or enhanced by absorption and/or reflection by the rubber particles and/or by a color-enhancing ingredient also embedded within the beaded paint layer, such as metal flakes, mica, pigment, metallized beads or glass beads containing color, pigment, luminescent or phosphorescent coatings, holographic flakes or similar color enhancing additives. The present light-refractive paint layers scatter light across the paint layer, depending upon their degree of translucency, due to the content of fully-embedded transparent or translucent beads, and do not merely retro-reflect or focus applied light directly back to the source. To the contrary, the translucent glass beads refract direct and indirect light in all directions through the paint layer, to enhance the depth and richness of the color(s) of the paint layer or the underlying base layer.

The present bead-containing refractive paint compositions may be based upon volatile organic solvents, water or may be solvent-free spray powder compositions.

In the case of volatile organic solvent compositions, the solids content is maintained high, above about 60% solids, which is facilitated by the content of the rubber microparticles and the inert, solid glass beads, pigment, aluminum flakes, mica, etc., and the film-forming binder material comprises a heat-curable resin system such as a polyester, acrylic, polyurethane or epoxy resin system including a cross-linking agent.

The present paint compositions may be water-borne or aqueous compositions comprising a water soluble heat-curable, cross-linking binder material such as an acrylic acid ester resin, a methacrylic acid ester resin, a polyurethane polymer, or the like, the pelletized rubber, the microbead mixture comprising clear or translucent refractive beads and color enhancers such as pigmented, dyed, phosphorescent or luminescent reflective beads, pigments, metal flakes, mica, holographic flakes, etc.

In another embodiment of the invention the present compositions contain a volatile organic solvent or vehicle, but are prepared as high solids compositions containing the pelletized rubber, the refractive glass beads, color enhancers and a minor amount of the resinous binder material and solvent or vehicle.

### DETAILED DESCRIPTION

The most critical component of the present light-transmissive compositions is the mixture of pelletized rubber, and resinous binder/microbeads material. The microbeads comprise (a) translucent, preferably optically-clear, light-refracting microbeads; optionally (b) one or more color-enhancing additives such as reflective microbeads which are coated with or encapsulate a reflective material, such as aluminum microbeads or aluminum-coated glass microbeads, or which are coated with or encapsulate colored dye or pigment or luminescent or phosphorescent materials, or consist of pigments, dyes, metal flake, mica or holographic flake, to lend color, depth and intensity to the paint coatings.

The pelletized rubber particles or powder comprise ground elastomeric tire scrap preferably having particle sizes up to about 150μ, preferably devulcanized. Such particles, known as ground rubber crumb, or pelletized rubber, are produced by cryogenic grinding processes and are commercially-available.

The resinous film-forming binder materials are as discussed hereinbefore.

The present refractive microbeads preferably are glass bead mixtures having different particle sizes and different indexes of refraction. However, the maximum diameter of the refractive beads including refractive clear and/or colored beads preferably is at least 10% less than the thickness of the cured paint layer, and preferably is within the range of 10 and 20μ for automotive paints.

The microbeads may be formed in conventional manner from known glass compositions such as silica glass, quartz, soda-lime glass, electroconductive glass, etc. The beads may be cast from molten glass compositions applied to corresponding cavities on a drum or plate, or by spraying of the molten composition through a nozzle for air cooling, or by any of the conventional processes currently used to produce commercially-available clear or tinted glass microbeads.

The light-refractive beads must be light-transmissive and preferably are optically clear and have an index of refraction of from about 1.5 to 2.5, preferably 1.9 to 2.1 and mixtures thereof.

The optional light reflective color-enhancing beads may be optically-opaque, preferably vacuum-metallized, or phosphorescent-or luminescent-coated glass microspheres, which reflect or emit and disperse light from their surfaces into and through the refractive microbeads, or against the rubber microparticles and color enhancing pigments, dyes, flakes, etc., and through the refractive microbeads in the form of scattered or dispersed colored light which gives added depth and intensity to the visual appearance and color of the paint layer.

In the case of luminescent, electroluminescent or phosphorescent reflective beads, the beads are surface coated with, or encapsulate, conventional luminescent, electroluminescent or phosphorescent compositions known to the art and, where necessary, are electroconductive.

The present paint compositions provide a novel and unexpected advantage with respect to the inclusion of mica as the color-enhancing particles. Mica is a preferred additive to conventional automotive paints since it imparts a pearlescent appearance. However because of the flat, lamelliform structure of mica crystals, the mica particles sometimes protrude at the dried paint surface to form imperfections or “fish eyes”. The mixture of pelletized rubber, glass beads and mica particles avoids these problems since the paint flows or levels to provide surface pattern control in which the mica particles are retained within the paint layer.

The common element of all of the present pelletized rubber/ bead-containing compositions is the matrix or binder material for the light refracting, dispersing and enhancing microbead mixture.

Most commonly the present compositions are volatile vehicle-based coating compositions which are applied to a substrate, such as a light-diffusive, light-refractive paint composition applied to an anti-corrosion primed metallic automotive surface or to a colored base coating thereon, and dried. Such coating compositions may comprise water-soluble curable binder materials such as acrylic ester resins or polyurethane polyester resins. Such aqueous compositions generally contain about 60% to 70% water and 30% to 40% solids which includes between 10% and 20% of the refractive microbead mixture, 2% to 40% of the pelletized rubber, 5% to 15% of the binder resin and the remainder consisting of one or more optional color-enhancing additives for imparting desired properties to the paint.

The formulation and application of the present compositions, such as paints for automobiles, boats, airplanes, appliances and a variety of other uses will be apparent to those skilled in the art in the light of the present disclosure.

The present paint coatings may comprise a single light-refractive color layer covered by a clear top-coat, or a colored base layer covered by a light-refracting tint layer and a clear top-coat.

In the case of automotive paints, the base metal body is first bathed or showered with a corrosion-resisting conversion coating or electrocoat, such as of zinc or iron phosphate or chromate and dried in an oven.

Subsequently a primer coating may be applied by dipping or flow coating, using a resinous binder of epoxy or alkyd polyester in organic solvent, followed by baking to harden the primer layer.

Next, the paint layer is sprayed over the primer layer, either as a single curable resinous paint layer or as a color-containing curable resinous base layer covered by a curable resinous bead-containing light-refracting tint layer. Each layer is baked to heat-cure the resinous binder material.

Finally a clear, colorless or tinted curable resinous top-coat is applied and baked to provide a hard protective, glossy exterior surface layer over the paint layer(s).

The preferred curable resinous binder system of the present coatings comprises the incorporation of both a cross-linkable polymer and a cross-linking agent which is reactive with groups on the polymer during heating or ultraviolet exposure to cure the polymer to a clear, hard, glass-like condition.

Water-based acrylic ester polymer/melamine-formaldehyde cross-linking resin mixtures provide curable binder material coatings having good resistance to ultraviolet light. Similar systems based upon organic solvent-soluble acrylic polymers and aldehyde resins are also suitable.

Solvent-based polyurethane coatings are also suitable, comprising a urethane prepolymer containing free isocyanate groups, as a polyisocyanate cross-linking agent, and an active hydrogen-containing polymer such as an —OH terminated polyester or polyether polymer.

A further advantage of the present glass-containing paint compositions, aside from the fact that the glass beads are inert, increase the solids content of the paint, and are easily reclaimable and recyclable, is that they provide the paint compositions with excellent spreadability, flow and leveling properties for ease and efficiency of application and surface pattern control.

The present pelletized rubber/glass bead paints containing color enhancers such as metallic flakes, colored metallic flakes and/or mica flakes, and colored mica flakes, provide richer, deeper automotive body colors and high specular flash or light scattering on the face of the color, i.e., when viewed directly, and a translucent rich deep elegant contrast when viewed at an angle, such on contoured body surfaces.

The content of the rubber particles and the glass spheres must be controlled to optimize the surface color quality, and varies with the paint color. With silver-colored or gray-colored metallic paints, the pelletized rubber and glass bead content each should be in the range of 5-10% by weight of the cured paint, preferably about 7%, whereas with darker colored paints the pelletized rubber and glass bead content should be in the range of 10-20% each by weight of the cured paint, preferably 12-15% each.

The following examples illustrate specific pelletized rubber/bead-containing paint compositions of different types coming within the present invention. It should be understood that such compositions are given by way of illustration only, and should not be considered limitative. In all cases, the layers are applied to conversion-coated or primed surfaces and are covered by conventional clear, glossy top coatings as currently used in the automotive paint industry.

### EXAMPLE 1

A red-colored metallic paint layer is applied in the form of two coatings, namely a metallic flake base coating and a red tint overcoating containing the rubber particles and clear glass beads. The base coating comprises:

Base Coat

| Ingredient | Parts by Volume |
|---|---|
| phthalocyanine blue | 3.4 |
| bright coarse aluminum flake | 145.0 |
| blue color-coated flake | 16.8 |
| medium aluminum flake | 50.6 |
| blue-toned graphite | 1.7 |
| polyester/acrylic resin binder | 202.4 |

The base composition is sprayed onto a primed metal auto body section and dried in a flash booth at 70-75° F., 63-68% humidity. The dried part is moved to a color bake oven and the paint is baked at 250° F. for 20-30 minutes to form a 1-mil thick base layer before application of the following tint coating thereover.

Tint Coat

| Ingredient | Parts by Volume |
|---|---|
| clear glass beads (10μ) | 100 |
| pelletized rubber (120μ | 10 |
| red toner | 10 |
| violet toner | 9 |
| clear resin and binder | 300 |

The tint-coated part is dried and then bake-cured in the same manner as the base coated part to form a 4-mil tint coat layer, and a final clear top coat of heat-curable resin is applied, dried and bake-cured to form a durable, chip-resistant, smooth, glossy outer surface layer, also having a thickness of about 1-mil.

### EXAMPLE 2

This example illustrates a single paint composition containing the light refractive beads, pelletized rubber and the color-enhancing agents for producing a light-refracting metallic gray paint layer.

| Ingredients | Parts by Volume |
|---|---|
| med. aluminum flake | 40.0 |
| carbon black | 150.0 |
| phthalocyanine blue | 20.0 |
| Hostaperm Violet | 15.0 |
| glass beads 12μ, (1.9 + 2.1 RI) | 20.0 |
| pelletized rubber (120μ) | 20.0 |
| curable binder | 180.0 |

The paint composition is sprayed over a primer-coated auto body part, dried and bake-cured in the same manner as in Example 1, to form a light-refractive color-enhancing paint layer having a thickness of about 1-mil (25μ). A final clear top-coat is applied and cured, as in Example 1, to form the durable, chip-resistant, smooth, glossy outer surface layer.

### EXAMPLE 3

This example is similar to Example 1 in that it relates to the application of a base layer and the subsequent application of a bead-containing, pelletized rubber-containing tint layer thereover. However the base layer has a greenish color and the tint layer contains phosphor-coated (strontium sulfide) glass beads.

Base Layer

| Ingredients | Parts by Volume |
|---|---|
| phthalocyanine green (yellow shade) | 10.9 |
| phthalocyanine green (blue shade) | 10.9 |
| light chrome yellow | 15.1 |
| white pigment | 344.4 |
| black pigment | 0.8 |
| curable resin binder | 37.8 |

The base layer is dried and bake-cured to a 1-mil thickness as in Example 1, and then spray-coated with the following tint layer:

| Ingredients | Parts by Volume |
|---|---|
| gold mica | 46.7 |
| phosphorous beads | 32.2 |
| clear glass beads (10-20μ) | 30.0 |
| pelletized rubber (120μ) | 20.0 |
| curable resin binder | 311.0 |

The tint layer is also dried and bake-cured to a 1-mil thickness, and then sprayed with a curable resinous clear top coat to provide the outer protective glossy surface layer.

### EXAMPLE 4

This example is similar to Example 2 in that it relates to the application of a single paint layer containing pelletized rubber, glass beads and blue color-enhancing agents.

| Ingredients | Parts by Volume |
|---|---|
| phthalocyanine blue | 100 |
| Hostaperm Violet | 20 |
| carbon black | 125 |
| fine blue mica | 3 |
| glass beads (12μ, 1.9 + 2.1 RI) | 15 |
| pelletized rubber (120μ) | 10 |
| curable resin binder | 160 |

The paint composition is spray-applied over a primed auto body part, dried and bake-cured as in Example 1, to form a refractive blue paint layer of about 1-mil thickness. The final clear top-coat is applied and bake-cured to form the protective, glossy surface layer.

In all cases, the formed paint layers are not retroreflective. Light applied thereagainst is refracted, scattered and diffused to some extent through the layers and enhanced by the colors of the pelletized rubber, pigments, dyes and flakes contained within the layers to provide a rich, deep appearance to the color of the paint. The glass microbeads are more firmly bound to the resin binder materials within the various layers, and the bead layers are more firmly bonded to the substrates due to the inclusion of the pelletized rubber.

While the present invention has been described in terms of specific embodiments and combinations, it will be appreciated that the invention is not limited to the particular examples presented herein, and that the scope of the protection is defined in the attached claims.

What is claimed is:

1. Light-refracting, color-enhancing compositions for applying coatings to a substrate, comprising a mixture of (a) pelletized rubber and (b) transparent or translucent glass plastic beads having a diameter up to about 70μ and (c) a resinous binder material which cures to form a hard, translucent, light-refracting paint layer.

2. A coating composition according to claim 1 in which the beads have a maximum diameter within the range of about 10 to 20 microns.

3. A coating composition according to claim 2 in which the maximum diameter is between 12 and 18 microns.

4. A coating composition according to claim 1 in which the beads are clear glass and have a refractive index between about 1.5 and 2.5.

5. A coating composition according to claim 4 in which the refractive index is between about 1.9 and 2.1.

6. A coating composition according to claim 4 in which the glass beads comprise a mixture of beads having different refractive indexes.

7. A coating composition according to claim 1 in which the pelletized rubber particles have a diameter up to about 150μ.

8. A coating composition according to claim 1 in which the pelletized rubber content is between about 2% and 40% by weight.

9. A coating composition according to claim 1 in which the binder material comprises a mixture of a pre-polymer having reactive sites, and a poly-functional cross-linking agent which is reactive with said sites to cure the binder material.

10. A coating composition according to claim 1 in which the resinous binder material contains a volatile solvent or vehicle which is evaporated to dry the coating below the baking temperature of the paint composition.

11. A coating composition according to claim 10 in which the volatile solvent is an organic solvent, and the coating composition has a solids content above about 60%.

12. A coating composition according to claim 10 in which the volatile vehicle is water.

13. A coating composition according to claim 1 in which the glass bead content is between about 10-20% by weight of the composition.

14. Process for applying a light-refractive, color-enhancing coating to a substrate comprising the steps of
(1) spraying said substrate with a coating composition comprising (a) at least 2% by weight of pelletized rubber and (b) at least about 10% by weight of transparent or translucent glass beads having a diameter up to about 70μ and (c) a curable resinous binder material; (2) heating the coating, if necessary to evaporate any volatile solvent or vehicle, and (3) drying the coating to cure the resinous binder material and form a light-refracting coating containing the pelletized rubber and the glass beads which refract, scatter and dissipate applied light within the cured coating and which is firmly bonded to said substrate.

15. Process according to claim 14 in which the pelletized rubber particles have a diameter up to about 150 microns.

16. Process according to claim 14 in which the pelletized rubber content is up to about 40% by weight of the solids content.

17. Process according to claim 14 in which the pelletized rubber content is between about 5% and 20% by weight of the solids content.
